(19) United States
(12) Patent Application Publication
(10) Pub. No.: US 2006/0080529 A1
(43) Pub. Date: Apr. 13, 2006

(54) Digital rights management conversion method and apparatus

(75) Inventors: Young-sun Yoon, Suwon-si (KR); Chi-hurn Kim, Hwaseong-si (KR); Ji-young Moon, Suwon-si (KR); Yang-lim Choi, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/242,062

(22) Filed: Oct. 4, 2005

Related U.S. Application Data
(60) Provisional application No. 60/616,626, filed on Oct. 8, 2004.

(30) Foreign Application Priority Data
Nov. 9, 2004 (KR) 10-2004-0090758

(51) Int. Cl. H04L 9/00

(52) U.S. Cl. 713/168

(57) ABSTRACT

A digital rights management (DRM) conversion method and apparatus are provided. The DRM conversion method includes: (a) obtaining a first content key for the first content and a second content key for the second content through reciprocal authentication between a DRM conversion apparatus and a DRM conversion server, the DRM conversion apparatus converting the first content into the second content; and (b) converting the first content into the second content wherein the DRM conversion apparatus is disconnected from the DRM conversion server. Accordingly, it is possible to transmit content between devices using different DRM systems even offline with the use of a conversion manager (CM) that performs authentication and DRM conversion operations.

This application claims the benefit of Korean Patent Application No. 10-2004-0090758, filed on Nov. 9, 2004, in the Korean Intellectual Property Office and U.S. Provisional Patent Application No. 60/616,626, filed on Oct. 8, 2004, in the U.S. Patent & Trademark Office, the disclosures of which are incorporated herein in their entirety by reference.

### BACKGROUND OF THE INVENTION

1. Field of the Invention

The present invention relates to a digital rights management (DRM) conversion apparatus and method, and more particularly, to a DRM conversion apparatus and method which enable devices using different DRM systems to transmit content to each other offline.

2. Description of the Related Art

A digital rights management (DRM) system is a system that manages content so that only users who have been successfully authenticated in an appropriate manner are allowed to use the content. In general, a DRM system includes a content server, which provides content, a license server, which allots a right to the content to a user, changes the right to the content, and withdraw the right to the content from the user, and a user device, which is given the right to the content and enables the user to use the content.

A DRM server application program and a DRM client application program are respectively installed in the license server and the user device. Currently, a variety of DRM application programs, such as Thompson's SmartRight, Cysco Systems' Open Conditional Content Access Management (OCCAM), IBM's xCP Cluster Protocol, and Digital Transmission License Administrator (DTLA)'s Digital Transmission Content Protection (DTCP), are available.

FIG. 1 is a diagram illustrating a typical DRM system. Referring to FIG. 1, a device 1 transmits a message requesting content desired by a user to a content server 2.

The content server 2 transmits content 5 to the device 1. Suppose that the content 5 has been encrypted using encryption keys and an encryption method prescribed by a DRM system DRM A and usage restriction information, such as usage rules, a maximum number of times that the content can be reproduced, and the expiration date of a right to reproduce the content, is recorded in the content 5 following a format prescribed by DRM A.

The device 1 transmits a message 6 requesting a license 7 for the content 5 to the license server 3. The license 7, which is a certificate of title for the content 5, contains decryption keys used for decrypting the content 5 and the usage restriction information. For example, if the content 5 has been created using DRM A, the device 1 can use the content 5 only after receiving a license created in a manner prescribed by the DRM A system.

The license server 3 determines whether a user of the device 1 is an authorized user. If the user of the device 1 is an authorized user, the license 7 is generated and then transmitted to the device 1. The license 7 includes decryption keys and usage restriction information used in DRM A.

The license server 3 and the content server 2 may be integrated into a DRM server 8.

The device 1 reproduces the content 5 using the license 7. Specifically, a DRM client application program installed in the device 1 extracts decryption keys for decrypting the content 5 and usage restriction information from the license 7 and determines whether usage of the content 5 violates the usage restriction information based on the usage restriction information, particularly, a maximum number of times the content 5 can be reproduced and the expiration date of the right to reproduce the content 5. If the usage of the content 5 does not violate the usage restriction information, the device 1 decrypts the content 5 using the decryption keys and reproduces the decrypted content 5.

The format of a license differs from DRM system to DRM system. Thus, in order to enable devices using different DRM systems, a DRM conversion operation needs to be performed.

FIG. 2 is a diagram illustrating a conventional DRM conversion method. Referring to FIG. 2, DRM A-to-DRM B conversion is a process of converting content Cont_A which has been created using a DRM system DRM A installed in a device Dev_A, so that a device Dev_B, in which a DRM system DRM B is installed, can reproduce the content Cont_A received from the device Dev_A. The devices Dev_A and Dev_B belong to the same home network, i.e., a home network 200.

The DRM system DRM A is installed in the device Dev_A, and the DRM system DRM B is installed in the device Dev_B. The content Cont_A has been created using the DRM system DRM A and is stored in the device Dev_A. The content Cont_A is transmitted from the device Dev_A to the device Dev_B after converted to be compatible with the DRM system DRM B, in other words, after converted into content Cont_B.

Specifically, the content Cont_A is content that has been encrypted using encryption keys defined in the DRM system DRM A and requires a license Lic_A having a format provided by the DRM system DRM A.

In operation 202, the device Dev_A transmits a message indicating that the device Dev_B uses the DRM system DRM B and has issued a request for the content Cont_A to a DRM conversion server S_conv together with the content Cont_A and the license Lic_A.

In operation 204, the DRM conversion server S_conv converts the content Cont_A into the content Cont_B.

In operation 206, the DRM conversion server S_conv receives a license Lic_B required for using the content Cont_B from a DRM B server S_B.

In operation 208, the DRM conversion server S_conv transmits the content Cont_B and the license Lic_B to the device Dev_B.

The conventional DRM conversion method, however, requires the device Dev_B to obtain the license Lic_B from a DRM server S_B via the DRM conversion server S_conv, which is inconvenient. In other words, it is inconvenient to obtain the license Lic_B from the DRM server S_B using an online network whenever there is the need to transmit the content Cont_A from the device Dev_A to the device Dev_B.

### SUMMARY OF THE INVENTION

The present invention provides a DRM conversion apparatus and method which can convert content from one DRM format to another DRM format without the need to obtain a license from a license server whenever there is the need to use the content, so that the content can be freely transmitted between devices using different DRM systems.

According to an aspect of the present invention, there is provided a digital rights management (DRM) conversion method which converts first content that has been created by a first device using a first DRM system into second content for a device using a second DRM system. The DRM conversion method includes: (a) obtaining a first content key for the first content and a second content key for the second content using reciprocal authentication between a DRM conversion apparatus and a DRM conversion server, the DRM conversion apparatus converting the first content into the second content; and (b) converting the first content into the second content wherein the DRM conversion apparatus is disconnected from the DRM conversion server.

Operation (b) may include: (b1) receiving the first content and a license for the first content from the first device; and (b2) generating the second content using the first content key, the second content key, and the first content.

Operation (b2) may include: (b21) decrypting the first content using the first content key; and (b22) generating the second content by encrypting the decryption results using the second content key.

Operation (b) may also include (b3) generating a new version of the first license and a second license for the second content using the first license and the second content key.

The first license may include first usage rule information that specifies rules regarding the usage of the first content, and the second license may include second usage rule information that specifies rules regarding the usage of the second content.

The first usage rule information may include first copy number information that specifies a maximum number of times the first content can be copied, and the second usage rule information may include second copy number information that specifies a maximum number of times the second content can be copied. Here, the first copy number information and the second copy number information are modified with respect to each other.

Whenever the second content is generated, a value of the second copy number information may increase by 1 , and a value of the first copy number information may decrease by 1.

According to another aspect of the present invention, there is provided a DRM conversion apparatus which converts first content that has been created by a first device using a first DRM system into second content for a device using a second DRM system. The DRM conversion apparatus includes an authentication unit, which receives a first content key for the first content and a second content key for the second content from a DRM, conversion server after authenticating and being authenticated by the DRM conversion server. Here, the first content is converted into the second content with the DRM conversion apparatus disconnected from the DRM conversion server.

### BRIEF DESCRIPTION OF THE DRAWINGS

The above and other features of the present invention will become more apparent by describing in detail exemplary embodiments thereof with reference to the attached drawings in which:

FIG. 1 is a diagram illustrating a typical digital rights management (DRM) system;

FIG. 2 is a diagram illustrating a conventional DRM conversion method;

FIG. 3 is a diagram illustrating a DRM conversion method according to an exemplary embodiment of the present invention;

FIG. 4 is a block diagram of a conversion manager of FIG. 3;

FIG. 5 is a flowchart of a method of converting first content having a DRM format supported by a first device into second content having a DRM format supported by a second device;

FIG. 6 is a diagram illustrating a DRM conversion method according to an exemplary embodiment of the present invention; and

FIG. 7 is a block diagram of an example of a conversion manager of FIG. 6.

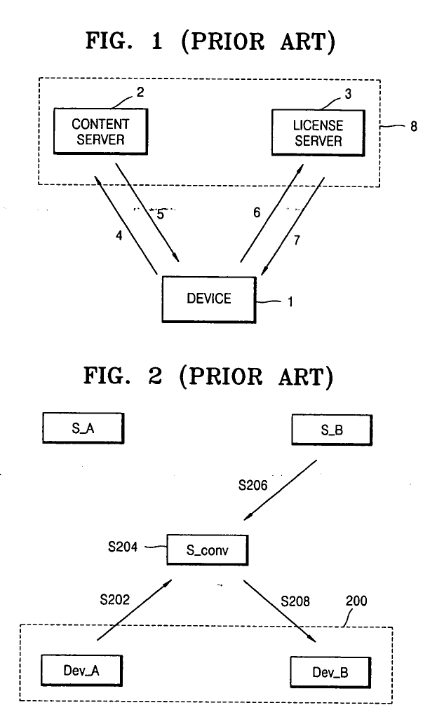

### DETAILED DESCRIPTION OF EXEMPLARY EMBODIMENTS OF THE INVENTION

The present invention will be described more fully with reference to the accompanying drawings in which exemplary embodiments of the invention are shown.

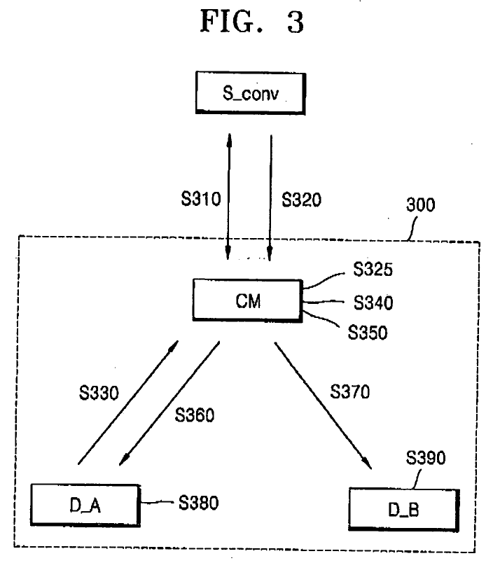

FIG. 3 is a diagram illustrating a digital rights management (DRM) conversion method according to an exemplary embodiment of the present invention. Referring to FIG. 3, in operation 310, a DRM conversion server S_conv authenticates a conversion manager (CM).

The DRM conversion server S_conv of FIG. 3, like the DRM conversion server S_conv of FIG. 2, has first and second content keys Kc_A and Kc_B. The first content key Kc_A is for first content C_A that has been created using a DRM system DRM A, and the second content key Kc_B is for second content C_B that has been created using a DRM system DRM B. The first content key Kc_A satisfies the following equation: C_A=E(Kc_A, C). Likewise, the second content key Kc_B satisfies the following equation: C_B=E(Kc_B, C).

The first content key Kc_A and the second content key Kc_B can be obtained from a first DRM server S_A of the DRM system DRM A and a second DRM server S_B of the DRM system DRM B, respectively.

The DRM conversion server S_conv authenticates the CM by determining whether a user of the CM is an authorized user who can receive the first and second content keys Kc_A and Kc_B. For example, the DRM conversion server S_conv may authenticate the CM by determining whether the user of the CM has paid for the first and second contents C_A and C_B. The authentication of the CM may be performed in various manners through, for example, exchange of messages, which is obvious to those skilled in the art.

In operation 320, if the CM has been successfully authenticated, the DRM conversion server S_conv transmits the first and second content keys Kc_A and Kc_B to the CM.

The CM is a device that performs a DRM conversion operation on content transmitted between a first device Dev_A and a second device Dev_B. Here, the DRM conversion operation involves all processes required for converting the first content C_A that has been created using the DRM system DRM A to be compatible with the second device D_B in which the DRM system DRM B is installed. The CM exists in a home network 300 and is connected to the DRM conversion server S_conv via, for example, the Internet.

In operation 325, the CM is disconnected from the DRM conversion server S_conv.

In the present exemplary embodiment, the DRM conversion server S_conv does not need to be connected to the CM all the time. Once the first and second content keys Kc_A and Kc_B are stored in the CM after the authentication of the CM, the CM may be disconnected from the DRM conversion server S_conv. However, the CM should be connected to the first and second devices D_A and D_B in order to convert the first content C_A into the second content C_B.

In operation 330, the CM receives the first content C_A and a first license L_A from the first device D_A. The first license L_A contains the first content key Kc_A and first usage rule information UR_A concerning the first content C_A. The first usage rule information UR_A includes information on a maximum number of times the first content C_A can be copied, i.e., first copy number information N_A.

In operation 340, the CM generates the second content C_B using the first content key Kc_A, the second content key Kc_B, and the first content C_A, which will be described in the following in greater detail.

The first content C_A is decrypted using the first content key Kc_A, thereby generating content C. Thereafter, the content C is encrypted using the second content key Kc_B, thereby generating the second content C_B.

In operation 350, the CM generates a new first license L_A′, which is a new version of the first license L_A, and a second license L_B using the first license L_A and the second content key Kc_B. When the new first license L_A′ and the second license L_B are generated, the first usage rule information contained in the first license L_A is converted accordingly to be compatible with the new first license L_A′ and second usage rule information UR_B to be contained in the second license L_B is generated.

Specifically, the CM extracts the first usage rule information UR_A from the first license L_A and extracts the first copy number information N_A from the first usage rule information UR_A.

Thereafter, the CM newly sets second copy number information N_B and generates the second usage rule information UR_B using the second copy number information N_B. The second copy number information N_B may be set based on a user's choice.

Thereafter, the CM updates the first copy number information N_B, thereby obtaining an updated first copy number information N_A′. The updated first copy number information N_A′ satisfies the following equation: N_A′=N_A−N_B. Thereafter, an updated first usage rule information UR_A′, which is an updated version of the first usage rule information UR_A, is generated using the updated first copy number information N_A′, and the first new license L_A′ is generated using the updated first usage rule information UR_A′ and the first content key Kc_A.

For example, if the first copy number information N_A is set to 8 and the second copy number information is set to 1, the updated first copy number information is set to 7. In other words, the first content C_A can be copied or reproduced a maximum number of 7 times, and the second content C_B can be copied or reproduced only one time.

In operation 360, the CM transmits the new first license L_A′ generated in operation 350 to the first device D_A.

In operation 370, the CM transmits the second content C_B generated in operation 340 and the second license L_B generated in operation 350 to the second device D_B.

In operation 380, the first device D_A uses the first content C_A using the new first license L_A′ received from the CM in operation 360. A maximum number of times the first device D_A can use the first content C_A is determined by the updated first copy number information N_A′ contained in the new first license L_A′.

In operation 390, the second device D_B uses the second content C_B using the second license L_B received from the CM in operation 370. A maximum number of times the second device D_B can use the second content C_B is determined by the second copy number information N_B contained in the second license L_B.

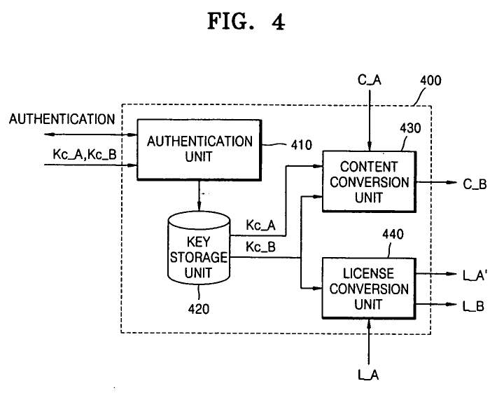

FIG. 4 is a block diagram of an example of the CM of FIG. 3, i.e., a CM 400. Referring to FIG. 4, the CM 400 includes an authentication unit 410, a key storage unit 420, a content conversion unit 430, and a license conversion unit 440.

The authentication unit 410 authenticates the DRM conversion server S_conv and helps the DRM conversion server S_conv authenticate the CM 400. If the CM and the DRM conversion server S_conv have successfully authenticated each other, the authentication unit 410 receives the first and second content keys Kc_A and Kc_B from the DRM conversion server S_conv and stores the received first and second content keys Kc_A and Kc_B in the key storage unit 420.

The authentication of the CM 400 is performed by determining whether a user of the CM 400 is an authorized user who can receive the first and second content keys Kc_A and Kc_B. For example, the CM 400 is authenticated by determining whether the user of the CM 400 has paid for the first and second contents C_A and C_B. The authentication of the CM 400 may be performed in various manners through, for example, exchange of messages, which is obvious to those skilled in the art.

Once the first and second content keys Kc_A and Kc_B are stored in the key storage unit 420, the CM 400 may be disconnected from the DRM conversion server S_conv.

The content conversion unit 430 generates the second content C_B using the first content key Kc_A, the second content key Kc_B, and the first content C_A, which will be described in the following in greater detail.

The content conversion unit 430 generates the content C by decrypting the first content C_A using the first content key Kc_A in response to a request for the second content C_B issued by the second device D_B.

The license conversion unit 440 generates a new first license L_A′, which is a new version of the first license L_A, and the second license L_B using the first license L_A and the second content key Kc_B. When the new first license L_A′ and the second license L_B are generated, the first usage rule information contained in the first license L_A is converted accordingly to be compatible with the new first license L_A′ and second usage rule information UR_B to be contained in the second license L_B is generated.

Specifically, the license conversion unit 440 extracts the first usage rule information UR_A from the first license L_A and extracts the first copy number information N_A from the first usage rule information UR_A in response to the request for the second content C_B issued by the second device D_B. Thereafter, the license conversion unit 440 newly sets the second copy number information N_B, generates the second usage rule information UR_B using the newly set second copy number information N_B, and generates the second license L_B using the second usage rule information UR_B. The second copy number information N_B may be set based on a user's choice.

Thereafter, the license conversion unit 440 updates the first copy number N_A, thereby generating the updated first copy number N_A′. Thereafter, the license conversion unit 440 generates the updated first usage rule information UR_A′, which is an updated version of the first usage rule information UR_A, using the updated first copy number information N_A′ and generates the new first license L_A′, which is a new version of the first license L_A, using the updated first usage rule information UR_A′ and the first content key Kc_A.

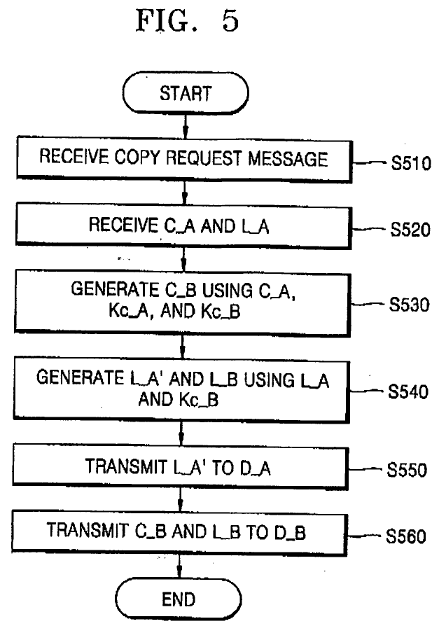

FIG. 5 is a flowchart of a method of converting first content C_A having a DRM format supported by a first device D_A into second content C_B having a DRM format supported by a second device D_B. Referring to FIG. 5, in operation 510, a CM receives a request for the second content C_B content from the second device D_B.

In operation 520, the CM receives the first content C_A and a first license L_A from the first device D_A.

In operation 530, the CM generates the second content C_B using the first content key Kc_A, the second content key Kc_B, and the first content C_A.

In operation 540, the CM generates a new first license L_A′, which is a new version of the first license L_A, and a second license L_B using the first license L_A and the second content key Kc_B.

In operation 550, the CM transmits the new first license L_A′ to the first device D_A.

In operation 560, the CM transmits the second content C_B generated in operation 530 and the second license L_B generated in operation 540 to the second device D_B.

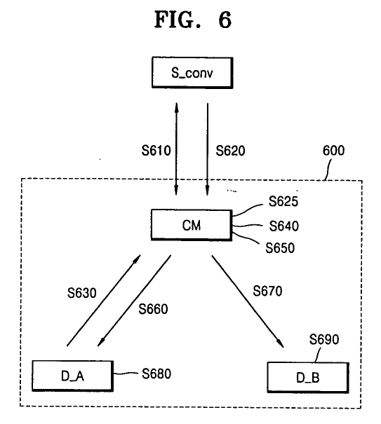

FIG. 6 is a diagram illustrating a DRM conversion method according to an exemplary embodiment of the present invention. Referring to FIG. 6, in operation 610, a DRM conversion server S_conv authenticates a CM.

In operation 620, if the CM is successfully authenticated, the DRM conversion server S_conv transmits a first content key Kc_A, a second content key Kc_B, and public and private keys Kcm_pub and Kcm_priv of the CM to the CM.

The first content key Kc_A, the second content key Kc_B, and the public and private keys Kcm_pub and Kcm_priv of the CM are transmitted using a license Lcm. The license Lcm may be expressed by Equation (1):
Lcm=E(ID_{—}cm, Kc_{—}A∥Kc_{—}B∥Kcm_pub∥Kcm_priv) (1)
where ID_cm is an identifier of the CM. In other words, the DRM conversion server encrypts the first content key Kc_A, the second content key Kc_B, and the public and private keys Kcm_pub and Kcm_priv of the CM using the identifier ID_cm of the CM and transmits the encryption results to the CM.

In operation 625, the CM is disconnected from the DRM conversion server S_conv.

In operation 630, the CM receives the first content C_A and the first license L_A from the first device D_A.

In operation 640, the CM generates the second content C_B using the first content key Kc_A, the second content key Kc_B, and the first content C_A.

As described above, the first content key Kc_A, the second content key Kc_B, and the public and private keys Kcm_pub and Kcm_priv of the CM are transmitted using the license Lcm, the CM retrieves the first content key Kc_A and the second content key Kc_B from the license Lcm by decrypting the license Lcm using the identifier ID_cm of the CM and then generates the second content C_B using the first content key Kc_A, the second content key Kc_B, and the first content C_A in operation 640.

In operation 650, the CM generates a new first license L_A′, which is a new version of the first license L_A, and a second license L_B using the first license L_A and the second content key Kc_B.

In operation 660, the CM generates a first signature value Sign_A by signing the new first license L_A′ generated in operation 650 using the private key Kcm_priv of the CM from the DRM conversion server S_conv received in operation 620 and transmits the first signature value Sign_A to the first device D_A. The first signature value Sign_A may be expressed by Equation (2):
Sign_{—}A=E(Kcm_priv, L_{—}A′) (2).

In operation 670, the CM generates a second signature value Sign_B by signing the second content C_B generated in operation 640 and the second license L_B generated in operation 650 using the private key Kcm_priv of the CM received from the DRM conversion server S_conv and transmits the second signature value Sign_B to the second device D_B. The second signature value Sign_B may be expressed by the following equation:
Sign_{—}B =E(Kcm_priv, C_{—}B∥L_{—}B) (3).

In operation 680, the first device D_A verifies the first signature value Sign_A using the public key Kcm_pub of the CM received from the DRM conversion server S_conv in operation 620, generates the first new license L_A′, and uses the first content C_A using the new first license L_A′. A maximum number of times the first device D_A can copy the first content C_A is determined by the first copy number information N_A′, which satisfies the following equation: N_A′=N_A−N_B.

In operation 690, the second device D_B verifies the second signature value Sign_B using the public key Kcm_pub of the CM received from the DRM conversion server S_conv in operation 620, generates the second license L_B and the second content C_B, and uses the second content C_B using the second license L_B.

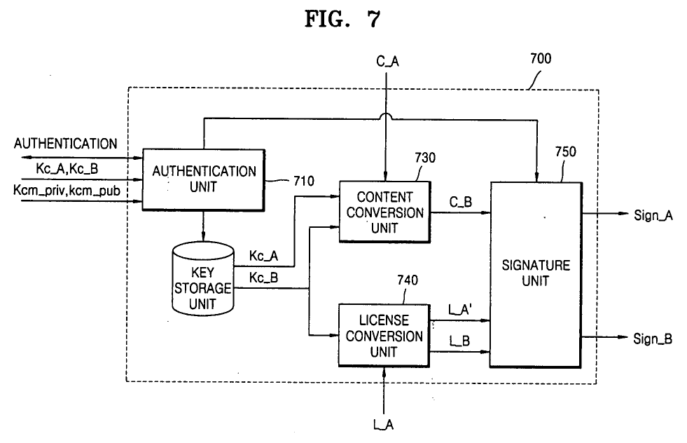

FIG. 7 is a block diagram of an example of the CM of FIG. 6, i.e., a CM 700. Referring to FIG. 7, the CM 700 includes an authentication unit 710, a key storage unit 720, a content conversion unit 730, a license conversion unit 740, and a signature unit 750.

The authentication unit 710 authenticates the DRM conversion server S_conv and helps the DRM conversion server S_conv authenticate the CM 700. If the CM and the DRM conversion server S_conv have successfully authenticated each other, the authentication unit 710 receives the first and second content keys Kc_A and Kc_B and the public and private keys Kcm_pub and Kcm_priv of the CM 700 from the DRM conversion server S_conv and stores the first and second content keys Kc_A and Kc_B and the public and private keys Kcm_pub and Kcm_priv of the CM 700 in the key storage unit 720.

Once the first and second content keys Kc_A and Kc_B and the public and private keys Kcm_pub and Kcm_priv of the CM 700 are stored in the key storage unit 720, the CM 700 may be disconnected from the DRM conversion server S_conv.

The content conversion unit 730 generates the second content C_B using the first content key Kc_A, the second content key Kc_B, and the first content C_A.

The license conversion unit 740 generates the new first license L_A′, which is a new version of the first license L_A, and the second license L_B using the first license L_A and the second content key Kc_B.

The signature unit 750 generates the first signature value Sign_A by signing the first license L_A′ using the private key Kcm_priv of the CM 700 received from the authentication signature value Sign_A to the first device D_A.

Likewise, the signature unit 750 generates the second signature value Sign_B by signing the second content C_B and the second license L_B received from the license conversion unit 740 using the private key Kcm_priv of the CM 700 received from the authentication unit 710 and transmits the second signature value Sign_B to the second device D_B.

In the exemplary embodiments of the present invention described with reference to FIGS. 3 through 7, the first content C_A and the first license L_A may be encrypted using a private key of the first device D_A and then transmitted to the CM, in which case, the CM may decrypt the encryption results using a public key of the first device D_A, thereby retrieving the first content C_A and the first license L_A.

In addition, the first content key Kc_A and the second content key Kc_B may be identical to each other. In this case, the DRM conversion server S_conv may receive only one of the first and second content keys Kc_A and Kc_B. However, regardless of whether the first content key Kc_A and the second content key Kc_B are identical to each other, licenses having different formats may be respectively issued to the first and second devices D_A and D_B.

The DRM conversion method according to an exemplary embodiment of the present invention may be written as a computer program. Codes and code segments of the computer program may be easily understood by those skilled in the art. The computer program is stored in a computer-readable recording medium and is read and executed by a computer. Examples of the computer-readable recording medium include a magnetic recording medium, an optical recording medium, and a carrier wave medium.

As described above, according to an exemplary embodiment of the present invention, it is possible to transmit content between devices using different DRM systems even offline with the use of a CM that performs authentication and DRM conversion operations.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A digital rights management (DRM) conversion method which converts first content that has been created by a first device using a first DRM system into second content for a device using a second DRM system, the DRM conversion method comprising:
(a) obtaining a first content key for the first content and a second content key for the second content using reciprocal authentication between a DRM conversion apparatus and a DRM conversion server, the DRM conversion apparatus converting the first content into the second content; and
(b) converting the first content into the second content wherein the DRM conversion apparatus is disconnected from the DRM conversion server.

2. The DRM conversion method of claim 1, wherein (b) comprises:
(b1) receiving the first content and a first license for the first content from the first device; and
(b2) generating the second content using the first content key, the second content key, and the first content.

3. The DRM conversion method of claim 2, wherein (b2) comprises:
(b21) decrypting the first content using the first content key; and
(b22) generating the second content by encrypting the decryption results using the second content key.

4. The DRM conversion method of claim 2, wherein (b) further comprises:
(b3) generating a new version of the first license and a second license for the second content using the first license and the second content key.

5. The DRM conversion method of claim 4, wherein the first license comprises first usage rule information that specifies rules regarding the usage of the first content, and the second license comprises second usage rule information that specifies rules regarding the usage of the second content.

6. The DRM conversion method of claim 5, wherein the first usage rule information comprises first copy number information that specifies a first maximum number of times the first content can be copied, and the second usage rule information comprises second copy number information that specifies a second maximum number of times the second content can be copied, wherein the first copy number information and the second copy number information are modified with respect to each other.

7. The DRM conversion method of claim 6, wherein whenever the second content is generated, a value of the second copy number information increases by 1 , and a value of the first copy number information decreases by 1.

8. The DRM conversion method of claim 4, wherein (b) further comprises:
(b4) transmitting the new version of the first license to the first device; and
(b5) transmitting the second content and the second license to the second device.

9. The DRM conversion method of claim 8, wherein (a) comprises:
(a1) obtaining public and private keys of the DRM conversion apparatus using reciprocal authentication between the DRM conversion apparatus and the DRM conversion server, wherein in (b4), the new version of the first license is transmitted to the first device after being electronically signed using the private key of the DRM conversion apparatus, and in (b5), the second license and the second content are transmitted to the second device after being electronically signed using the private key of the DRM conversion apparatus.

10. The DRM conversion method of claim 1, wherein the first and second content keys are identical to each other.

11. A DRM conversion apparatus which converts first content that has been created by a first device using a first DRM system into second content for a device using a second DRM system, the DRM conversion apparatus comprising:
an authentication unit, which receives a first content key for the first content and a second content key for the second content from a DRM conversion server after authenticating and being authenticated by the DRM conversion server,
wherein the first content is converted into the second content with the DRM conversion apparatus disconnected from the DRM conversion server.

12. The DRM conversion apparatus of claim 11 further comprising:
a content conversion unit, which generates the second content using the first content key, the second content key, and the first content; and
a license generation unit, which generates a new version of a first license for the first content and a second license for the second content using the first license and the second content key.

13. The DRM conversion apparatus of claim 12, wherein the content conversion unit generates the second content by decrypting the first content using the first content key and encrypting the decryption results using the second content key.

14. The DRM conversion apparatus of claim 13, wherein the first license comprises first usage rule information that specifies rules regarding usage of the first content, and the second license comprises second usage rule information that specifies rules regarding usage of the second content.

15. The DRM conversion apparatus of claim 14, wherein the first usage rule information comprises first copy number information that specifies a first maximum number of times the first content can be copied, and the second usage rule information comprises second copy number information that specifies a second maximum number of times the second content can be copied, wherein the first copy number information and the second copy number information are modified with respect to each other.

16. The DRM conversion apparatus of claim 15, wherein whenever the second content is generated, a value of the second copy number information increases by 1 , and a value of the first copy number information decreases by 1.

17. The DRM conversion apparatus of claim 12, wherein the authentication unit receives the first and second content keys and public and private keys of the DRM conversion apparatus from the DRM conversion server after authenticating and being authenticated by the DRM conversion server, wherein the DRM conversion apparatus further comprises a signature unit, which electronically signs the new version of the first license using the private key of the DRM conversion apparatus, transmits the electronically signed version of the first license to the first device, electronically signs the second content and the second license, and transmits the electronically signed second content and second license to the second device.

18. The DRM conversion apparatus of claim 11, wherein the first and second content keys are identical to each other.

19. A computer-readable recording medium storing a program for executing a DRM conversion method which converts first content that has been created by a first device using a first DRM system into second content for a device using a second DRM system, the DRM conversion method comprising:
(a) obtaining a first content key for the first content and a second content key for the second content using reciprocal authentication between a DRM conversion apparatus and a DRM conversion server, the CM converting the first content into the second content; and
(b) converting the first content into the second content wherein the conversion apparatus (CM) is disconnected from the DRM conversion server.
